(19) United States
(12) Patent Application Publication
(10) Pub. No.: US 2010/0034662 A1
(43) Pub. Date: Feb. 11, 2010

(54) COOLED AIRFOIL AND METHOD FOR MAKING AN AIRFOIL HAVING REDUCED TRAIL EDGE SLOT FLOW

(75) Inventors: Richard W. Jendrix, Liberty Township, OH (US); Cory Williams, Maineville, OH (US)

Correspondence Address: MCNEES WALLACE & NURICK LLC, 100 PINE STREET, P.O. BOX 1166, HARRISBURG, PA, 17108-1166, US

(73) Assignee: GENERAL ELECTRIC COMPANY, Schenectady, NY (US)

(21) Appl. No.: 11/616,176

(22) Filed: Dec. 26, 2006

(51) Int. Cl. F01D 5/18; B23P 15/02

(52) U.S. Cl. 416/97 R; 29/889.722

(57) ABSTRACT

An airfoil component having a body having a leading edge and a trailing edge, a ceramic casting insert for making the component and the method for making the component. The component includes an internal cooling passageway and an elongated opening in communication with the internal cooling passageway. The opening is configured with a geometry that provides structural stability during casting and has a cross-section that sufficiently restricts airflow through the opening to provide efficient component operation. The casting insert includes outer edge projections and a web portion corresponding to the geometry of the openings when cast around the insert. The method includes casting the airfoil component around the casting insert and removing the insert to provide the component having the openings.

### FIELD OF THE INVENTION

The present invention relates generally to gas turbine engine components, and more particularly to internally cooled airfoils used in gas turbine engine components.

### BACKGROUND OF THE INVENTION

Temperatures within gas turbines may exceed 3000° F. (1650° C.), and cooling of turbine blades is very important in terms of blade longevity. The gas turbine engine operates by utilizing a compressor portion to compress atmospheric air to 10-25 times atmospheric pressure and adiabatically heating the air to between about 800°-1250° F. (427° C.-677° C.) in the process. This heated and compressed air is directed into a combustor, where it is mixed with fuel. The fuel is ignited, and the combustion process heats the gases to very high temperatures, in excess of 3000° F. (1650° C.). These hot gases pass through the turbine, where airfoils fixed to rotating turbine disks extract energy to drive the fan and compressor of the engine and the exhaust system, where the gases provide sufficient thrust to propel the aircraft. To improve the efficiency of operation of the aircraft engine, combustion temperatures have been raised. Of course, as the combustion temperature is raised, steps must be taken to prevent thermal degradation of the materials forming the flow path for these hot gases of combustion.

Aircraft gas turbine engines have a so-called High Pressure Turbine (HPT) to drive the compressor. The HPT is located aft of the combustor in the engine layout and experiences the highest temperature and pressure levels (nominally—3000° F. (1850° C.) and 300 psia, respectively) developed in the engine. The HPT also operates at very high rotational speeds (10,000 RPM for large high-bypass turbofans, 50,000 for small helicopter engines). There may be more than one stage of rotating airfoils in the HPT. In order to meet life requirements at these levels of temperature and pressure, HPT components are air-cooled, typically from bleed air taken from the compressor, and are constructed from high-temperature alloys.

Without cooling, turbine blades would rapidly deteriorate. Improved cooling for turbine blades is very desirable, and much effort has been devoted by those skilled in the blade cooling arts to devise improved geometries for the internal cavities within turbine blades, in order to enhance cooling. Since the combustion gases are hot, the turbine vanes and blades are typically cooled with a portion of compressor air bled from the compressor for this purpose. Diverting any portion of the compressor air from use in the combustor necessarily decreases the overall efficiency of the engine. Accordingly, it is desired to cool the vanes and blades with as little compressor bleed air as possible.

Turbine rotor blades with internal cooling circuits are typically manufactured using an investment casting process commonly referred to as the lost wax process. This process comprises enveloping a ceramic core defining the internal cooling circuit in wax shaped to the desired configuration of the turbine blade. The wax assembly is then repeatedly dipped into a liquid ceramic solution such that a hard ceramic shell is formed thereon. Next, the wax is removed from the shell by heating so that the remaining mold consists of the internal ceramic core, the external ceramic shell and the space therebetween, previously filled with wax. The empty space is then filled with molten metal. After the metal cools and solidifies, the external shell is broken and removed, exposing the metal that has taken the shape of the void created by the removal of the wax. The internal ceramic core is dissolved via a leaching process. The resulting metal component has the desired shape of the turbine blade with the internal cooling circuit and cooling orifices.

In casting turbine blades with serpentine cooling circuits, the internal ceramic core is formed as a serpentine element having a number of long, thin branches. This presents the challenge of making the core sturdy enough to survive the pouring of the metal while maintaining the stringent requirements for positioning the core. Currently, the trail edge slots are cast utilizing substantially oval core insert projections that provide a slot size sufficiently large, typically greater than about 0.013 inches to provide strength to the core and provide sufficient cooling along the trail edge of the turbine component. FIG. 3 shows a known airfoil configuration having trailing edge openings 211 having a known arrangement along trailing edge 107. The trailing edge openings 211 have a substantially oval geometry (i.e., a geometry having a substantially uniform width across a length) that allows the passage of an excessive quantity of cooling fluid 204 and undesirably requires a cooling fluid 204 restriction, such as a root plate, on the cooling fluid 204 feed to provide efficient operation of the blade 100. Another view of a prior art arrangement is shown in FIG. 7, which illustrates a cross-section of a trailing edge opening 211, wherein the cross-sectional geometry has a substantially oval geometry. The trailing edge opening 211 known in the art was previously required to have a width 701 that is substantially uniform across the length 703 to provide sufficient ceramic core 501 strength during casting. However, the cooling slots currently formed provide excessive flow of cooling fluid at reduced cavity pressure during operation, requiring the use of a root plate 901 on the blade feed to limit the flow of cooling fluid. FIG. 9 shows a known turbine blade 100 arrangement having a root plate 901 disposed on inlet openings 205. The root plate undesirably increases manufacturing costs and provides additional maintenance costs by requiring the installation of an additional component adjacent the turbine component.

Accordingly, there is a need for an airfoil component in which cooling fluid flow through the trail edge slots is decreased, while the core during fabrication is sufficiently robust to withstand casting of the turbine component.

### SUMMARY OF THE INVENTION

A first aspect of the present invention includes an airfoil component having a body having a leading edge and a trailing edge. The component includes an internal cooling passageway and an elongated opening in communication with the internal cooling passageway. The opening is configured with a geometry that provides structural stability during casting and has a cross-section that sufficiently restricts airflow through the opening to provide efficient component operation.

Another aspect of the present invention includes a gas turbine engine component casting insert having a ceramic insert body. The insert further includes core insert projections extending from the body having outer edge projections connected by a web portion. The outer edge projections have a thickness along the web portion that is greater than the thickness of the web portion. The core insert projections and web portion have sufficient structural stability to permit casting around the insert.

Still another aspect of the present invention includes a method for casting a gas turbine engine component. The method includes providing a core insert having core insert projections with outer edge projections connected by a web portion. The outer edge projections have a thickness along the web portion that is greater than the thickness of the web portion. A gas turbine engine component is cast over the core insert. The core insert is then removed to provide a gas turbine engine having cooling passages and elongated openings in communication with the cooling passages. The opening formed from removal of the core insert have a geometry that sufficiently restricts airflow through the opening to provide efficient component operation.

An advantage of an embodiment of the present invention is that the amount of bleed air from the compressor may be reduced and gas turbine engine operation may be more efficient.

Another advantage of an embodiment of the present invention is that the reduced cooling flow of cooling fluid from the trailing edge reduces or eliminates the need for other fluid flow restrictions, such as root plates.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 illustrates an elevational perspective view of a turbine blade according to an embodiment of the present invention.

FIG. 2 illustrates a partial cutaway view of a turbine blade according to an embodiment of the present invention.

FIG. 3 illustrates a perspective view of an airfoil having trailing edge openings known in the art.

FIG. 4 illustrates a perspective view of an airfoil having trailing edge openings according to an embodiment of the present invention.

FIG. 5 illustrates a perspective view of a core insert according to an embodiment of the present invention.

FIG. 6 illustrates an enlarged perspective view of a core insert according to an embodiment of the present invention.

FIG. 7 illustrates a cross-sectional geometry of a trailing edge opening known in the art.

FIG. 8 illustrates a cross-sectional geometry of a trailing edge opening according to an embodiment of the present invention.

FIG. 9 illustrates a bottom perspective view a turbine blade having a root plate according to an embodiment of the present invention.

Wherever possible, the same reference numbers are used throughout the drawings to refer to the same or like parts.

### DETAILED DESCRIPTION OF THE INVENTION

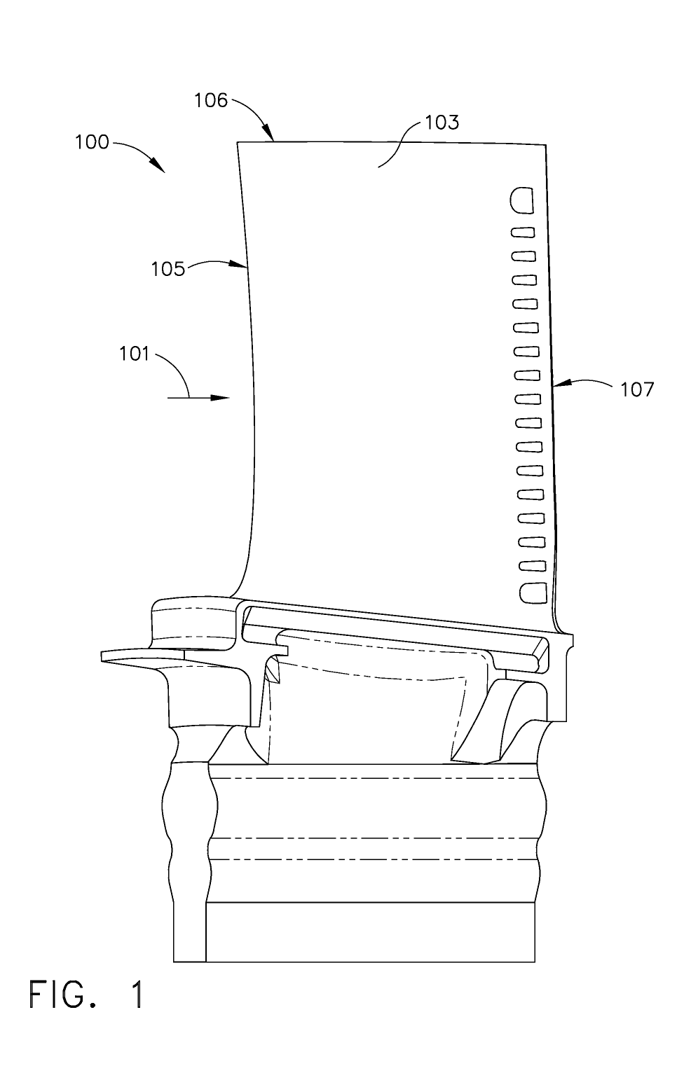

Illustrated in FIG. 1 is an exemplary turbine blade 100 for a gas turbine engine designed to be operated in a hot gas stream that flows in an axial flow downstream direction. During operation of the blade 100, combustion gases 101 are generated by a combustor (not shown) and flow downstream over the airfoil 103. The blade 100 includes a hollow airfoil 103 and a conventional root 104 used to secure the blade 100 to a rotor disk (not shown) of the gas turbine engine. The airfoil 103 includes an upstream leading edge 105, tip 106 and a downstream trailing edge 107 which is spaced chordally apart from the leading edge 105. The airfoil 103 extends longitudinally in a radial direction away from the root 104.

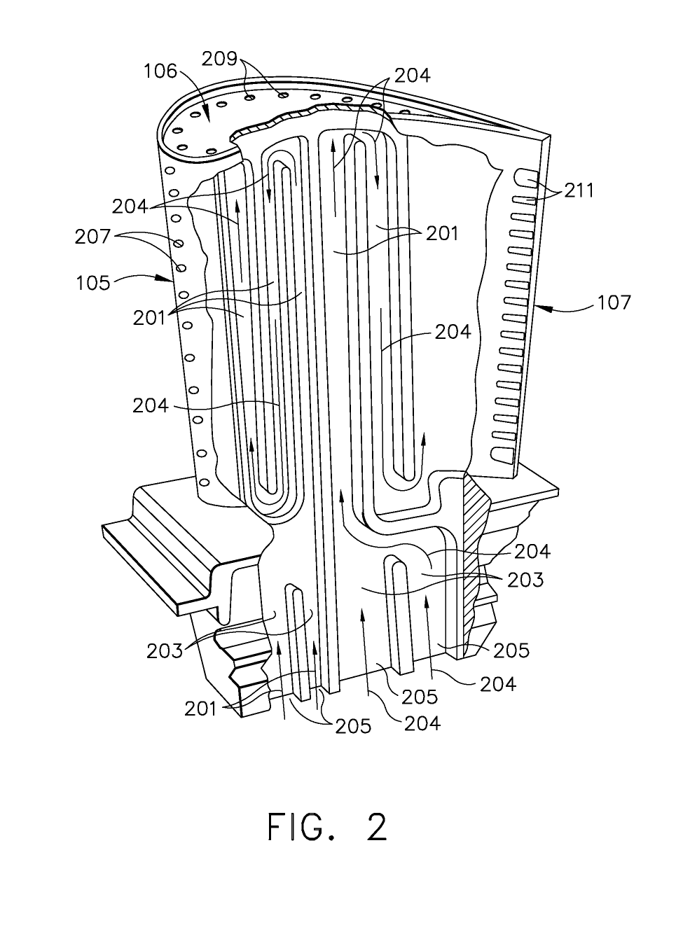

As shown in FIG. 2, the airfoil 101 includes an internal serpentine cooling circuit having cooling passages 201 traversing the hollow portions of airfoil 103. The configuration of cooling passageways 201 is not particularly limited and may include a plurality of circuits 203 that receives a cooling fluid 204, such as compressed air bled from the compressor of the gas turbine engine (not shown), through inlet openings 205. Preferably, serpentine cooling circuit 203 are constructed so as to cause a serpentine cooling fluid 204 within the cooling circuit 203 to flow through the passages 201 and exit through leading edge openings 207, tip openings 209, trailing edge openings 211. The flow of cooling fluid 204 thereby cools the airfoil 103 from the heat of the combustion gases 101 flowing over the outer surfaces thereof. In addition, airfoil 103 may include openings along the outer walls, the leading edge and/or the tip surfaces, as desired, to provide film cooling to various surfaces of the airfoil 103. As shown in FIG. 2, these film cooling openings 207 and 209 may be disposed through the outer wall along leading edge 105 and tip 106, respectively. The present invention is not limited to the arrangement of passages 201 or openings 207 and 209 shown and may include any suitable arrangement of passages 201 that provides cooling to the airfoil 103.

The trailing edge openings 211 receive a flow of cooling fluid 204 wherein the cooling fluid 204 flows through the trailing edge openings 211 and is discharged from the airfoil 103. Cooling air discharge apertures or trailing edge openings 211 are preferably designed to provide impingement cooling of the trailing edge 107. The present invention utilizes a configuration of trailing edge openings 211 that provides efficient cooling, without the need for a root plate or other cooling fluid 204 restriction, allowing for efficient gas turbine engine operation.

Although an exemplary gas turbine blade 100 is illustrated in FIGS. 1 and 2, the invention applies equally as well to substantially fixed turbine stator vanes having similar airfoils and turbine shrouds, which may be similarly cooled in accordance with the present invention. Further, the airfoil 103 may have any other conventional features for enhancing the cooling thereof, such as turbulators or pins (not shown), which are well known in the art. In addition, thermal barrier coatings (TBCs), which are well known in the technology, may also be used to improve thermal characteristics of the airfoil 103.

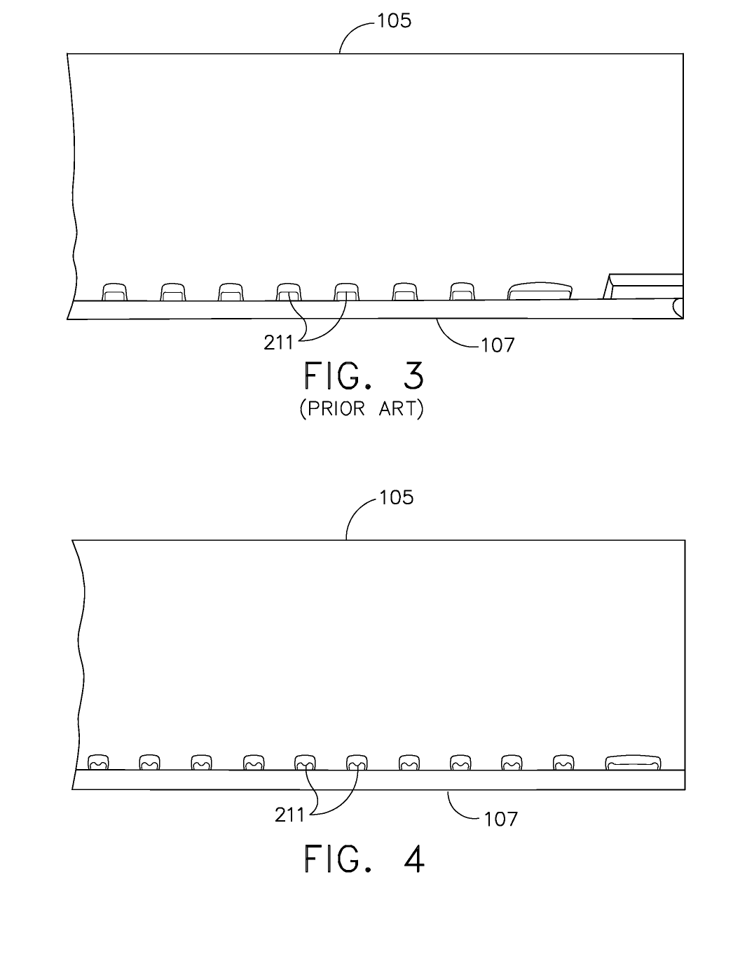

FIG. 4 shows an airfoil 103 having trailing edge openings 211 having an arrangement of trailing edge openings 211 along trailing edge 107 according to an embodiment of the present invention. In this embodiment, the trailing edge openings 211 having a pinched geometry that allow a flow rate of cooling fluid 204 that is less than the flow of cooling fluid 204 through the trailing edge openings 211 of FIG. 3. The reduced cooling fluid 204 flow provides efficient cooling, without the need for a root plate or other cooling fluid 204 restriction, allowing for efficient gas turbine engine operation.

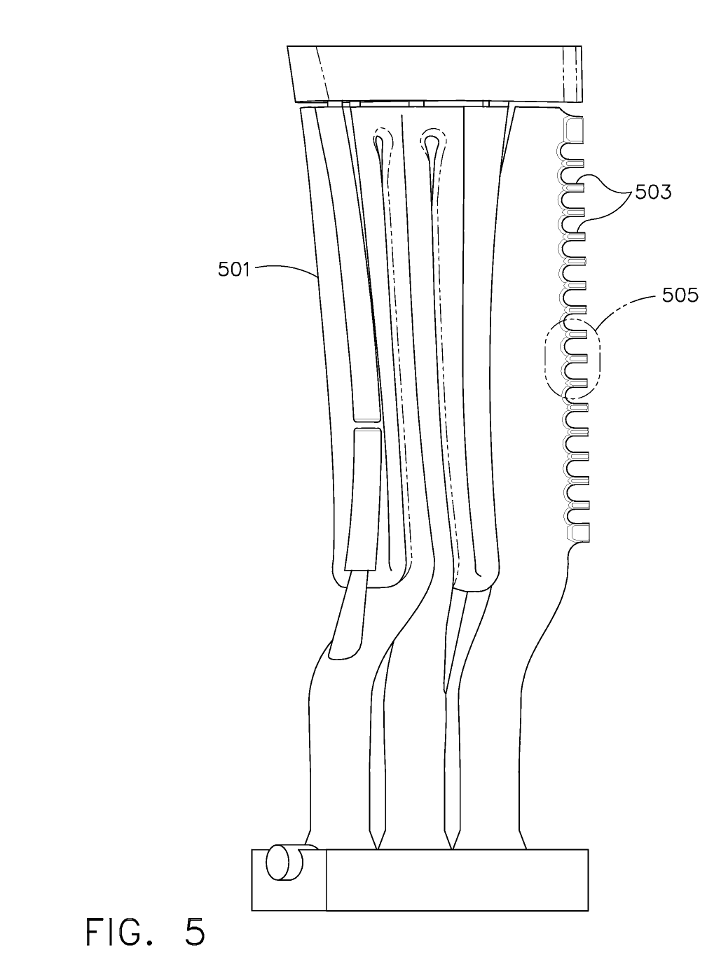

FIG. 5 shows a core assembly for casting turbine blades with serpentine cooling circuits, the internal ceramic core 501 is formed as a serpentine element having a number of long, thin branches. The internal ceramic core 501 is formed as a serpentine element having a number of long, thin branches. The ceramic core 501 has mechanical properties, such as strength, sufficient to withstand the pouring of casting material (e.g., superalloy metal) while maintaining the tight positioning requirement for the ceramic core 501 during casting. The casting of the turbine blade 100 may be performed using conventional turbine blade 100 casting methods. For example, the turbine blade 100 may be investment cast from a directionally solidified or single crystal superalloy around ceramic core 501. Upon completion of the casting and removal of the outer ceramic material, the ceramic core 501 may be chemically removed to provide the hollow turbine blade 100.

An embodiment of the present invention utilizes a ceramic core 501 that is formed utilizing cores insert projections 503 having a geometry corresponding to the pinched geometry trailing edge openings 211. The pinched trail edge openings 211 are cast utilizing ceramic core 501 insert projections 503 that provide a slot geometry having a pinched geometry to provide strength to the ceramic core 501 and provide sufficient cooling along the trailing edge opening 211 of the turbine component.

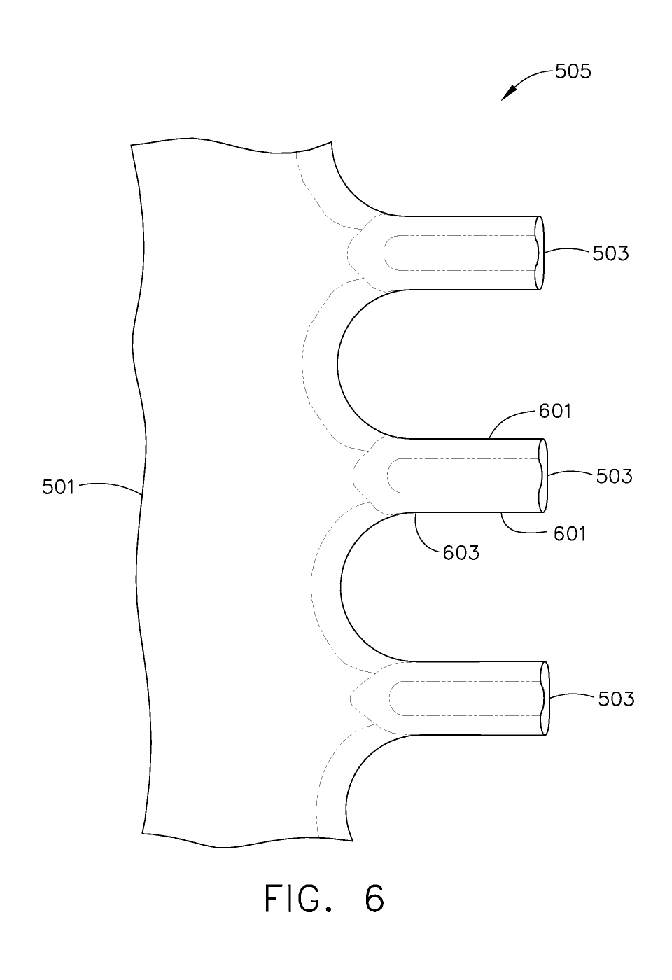

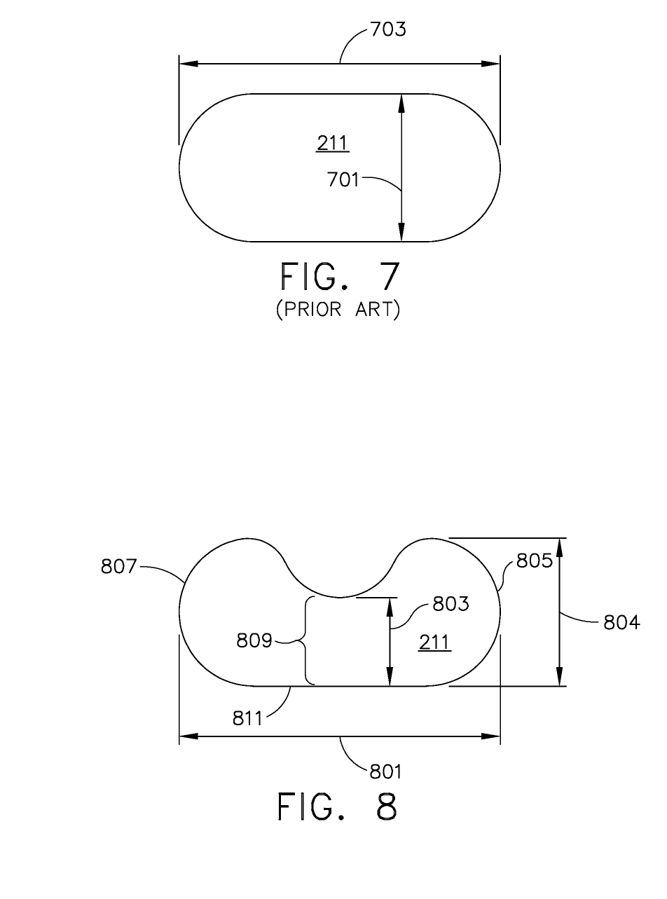

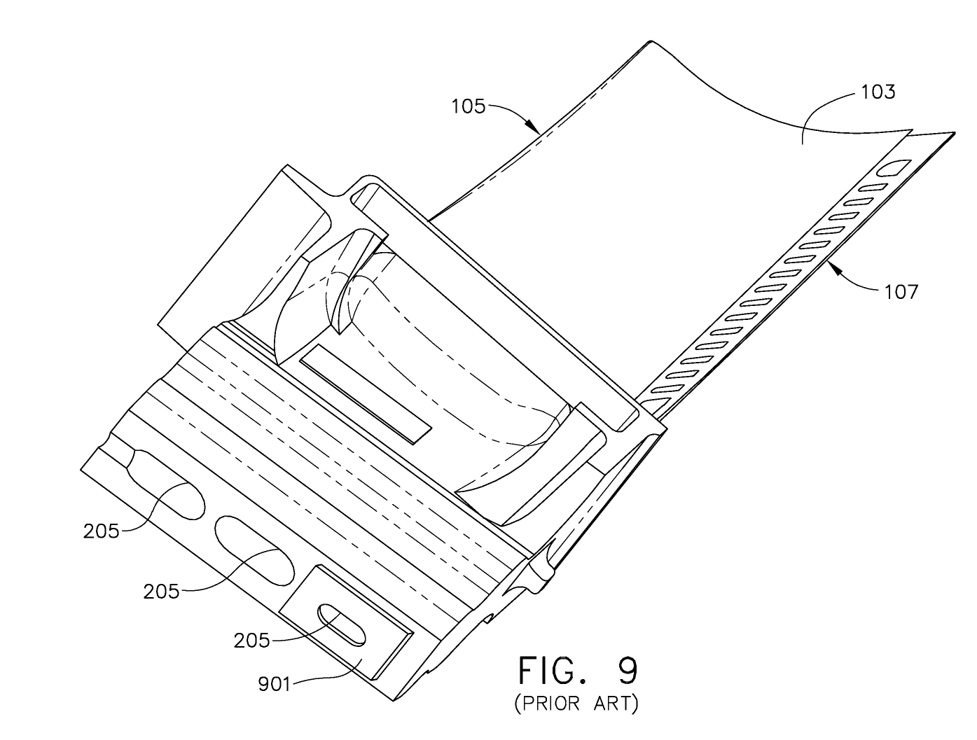

FIG. 6 shows an enlarged view of portion 505 of FIG. 5 illustrating ceramic core 501 insert projections 503. As better shown in the enlarged view of portion 505 in FIG. 6, the ceramic core 501 insert projection 503 geometry includes outer edge projections 601 providing one or more ribs or splines connected by a web portion 603, which extends between outer edge projections 601. While not limited to the geometry shown in FIGS. 5 and 6, the insert projections 503 preferably include a minimum and a maximum thickness across the length of the web portion 603. For example, the web portion 603 may have a thickness (i.e., a thickness measured along an axis into the paper, as shown in FIGS. 5 and 6) along the web portion 603 that is less than about 90% of the thickness of the outer edge projections 601, preferably the thickness of the web portion 603 is less than about 85% of the thickness of the outer edge projections 601 and more preferably the thickness web portion 603 is less than about 80% of the thickness of the outer edge projections 601. The combination of the outer edge projections 601 and the web portion 603 provides sufficient mechanical properties to permit casting of the turbine blade 100 and to maintain positioning during casting. The ceramic core 501 insert corresponds to geometry in the finished turbine blade 100 having trailing edge openings 211, when the ceramic core 501 insert is removed, that reduces or eliminates excessive flow of cooling fluid 204 at reduced cavity pressure during operation. The flow of cooling fluid 204 is sufficiently limited by the trailing edge openings 211 to reduce or eliminate the need for a root plate on the blade feed to limit the flow of cooling fluid 204.

FIG. 8 illustrates an embodiment of the invention having a pinched geometry. By pinched geometry it is meant that the cross-sectional geometry of the trailing edge opening 211 includes an elongated opening having a first dimension 801 arranged in the elongated direction and a second minimum dimension 803 and second maximum dimension 804 that are substantially perpendicular to the first dimension. The first dimension 801 includes a first end 805 and a second end 807 wherein the second minimum dimension 803 includes a minimum value at a location between the first end 805 and the second end 807. In a preferred embodiment, the trailing edge opening 211 has a pinched geometry wherein the first end 805 and second end 807 each include substantially circular cross-sectional geometries extending for a second maximum dimension 804 connected by a reduced thickness chord 809 extending along a side edge 811 of trailing edge opening 211. For example, the second maximum dimension 804 may have a maximum near the first end 805 and second end 807 of about 0.013 inches and the second minimum dimension 803 may be 0.010 inches along chord 809. The second minimum dimension 803 may be less than or equal to about 90% of the second maximum dimension 804, preferably less than or equal to about 85% of the second maximum dimension 804 and still more preferably 80% of the second maximum dimension 804.

In another embodiment of the invention, the trailing edge opening 211 may include a plurality of second minimum dimensions 803 between first end 805 and second end 807, for example, wherein the second maximum dimension 804 is located at a location near the center of first dimension 801 a substantially T-shaped opening 211. Likewise, the second maximum dimension 804 may extend in two directions past second minimum dimension 803. The present invention is not limited to the above configurations of the first dimension 801, the second minimum dimension 803 and second maximum dimension 804 and may include a plurality of each or both of the second minimum dimension 803 and second maximum dimension 804. The present invention utilizes the cross-sectional geometry formed to provide a reduced amount of cooling fluid 204 flow, while providing a sufficiently strong ceramic core 501 insert that allows casting of the blade 100. The cooling fluid 204 is therefore used more efficiently and less cooling fluid 204 is bled from the compressor for increasing the overall efficiency of operation of the gas turbine engine.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An airfoil component comprising:
a body having a leading edge and a trailing edge;
an internal cooling passageway;
an elongated opening, the opening being in communication with the internal cooling passageway; and
wherein the opening is configured with a geometry that provides structural stability during casting and has a cross-section that sufficiently restricts cooling fluid flow through the opening to provide efficient component operation.

2. The component of claim 1, wherein the opening has an elongated geometry having first dimension and a second dimension, the first dimension having a first end and a second end disposed at opposite ends of the opening; and
the second dimension being arranged perpendicular to the first dimension and further including at least one minimum value and at least one maximum value disposed between the first and second end.

3. The component of claim 2, wherein the at least one minimum value is less than about 90% of the maximum value.

4. The component of claim 3, wherein the at least one minimum value is less than about 80% of the maximum value.

5. The component of claim 1, wherein the openings are disposed adjacent the trailing edge.

6. The component of claim 1, wherein the component is a turbine blade or vane.

7. The component of claim 1, wherein the component is a turbine shroud.

8. A gas turbine engine component casting insert comprising:
a ceramic insert body;
core insert projections extending from the body having outer edge projections connected by a web portion, the outer edge projections having a thickness along the web portion that is greater than the thickness of the web portion; and
wherein the core insert projections and web portion have sufficient structural stability to permit casting around the insert.

9. The casting insert of claim 8, further comprising a gas turbine engine component cast around the body.

10. The casting insert of claim 9, wherein the component is a turbine blade or vane.

11. The casting insert of claim 9, wherein the component is a turbine shroud.

12. The casting insert of claim 9, wherein the ceramic insert body is chemically removable from the interior of the gas turbine component casting.

13. The casting insert of claim 8, wherein the web portion has a thickness along the web portion that is less than about 90% of the thickness of the outer edge projections.

14. The casting insert of claim 13, wherein the web portion has a thickness along the web portion that is less than about 80% of the thickness of the outer edge projections.

15. A method for casting a gas turbine engine component comprising:
providing core insert projections extending from the body having outer edge projections connected by a web portion, the outer edge projections having a thickness along the web portion that is greater than the thickness of the web portion;
casting a gas turbine engine component over the core insert;
removing the core insert to provide a gas turbine engine having cooling passages and elongated openings in communication with the cooling passages; and
wherein the opening formed from removal of the core insert has a geometry that sufficiently restricts airflow through the opening to provide efficient component operation.

16. The method of claim 15, wherein the opening has an elongated geometry having first dimension and a second dimension, the first dimension having a first end and a second end disposed at opposite ends of the opening; and
the second dimension being arranged perpendicular to the first dimension and further including at least one minimum value and at least one maximum value disposed between the first and second end.

17. The method of claim 16, wherein the at least one minimum value is less than about 90% of the maximum value.

18. The method of claim 17, wherein the at least one minimum value is less than about 80% of the maximum value.

19. The method of claim 15, wherein the component is a turbine blade or vane.

20. The method of claim 15, wherein the component is a turbine shroud.
